(19) United States
(12) Patent Application Publication
(10) Pub. No.: US 2004/0089274 A1
(43) Pub. Date: May 13, 2004

(54) Fuel delivery module integral resonator

(75) Inventor: Wayne Alan Nowicki, Ypsilanti, MI (US)

Correspondence Address: VISTEON 29074, BRINKS HOFER GILSON & LIONE, P.O. BOX 10395, CHICAGO, IL, 60611, US

(73) Assignee: Visteon Global Technologies, Inc.

(21) Appl. No.: 10/292,706

(22) Filed: Nov. 12, 2002

(51) Int. Cl. H02K 5/24

(52) U.S. Cl. 123/509; 181/202; 417/540

(57) ABSTRACT

A fuel delivery module for supplying fuel to an automobile is disclosed. The fuel delivery module has a receptacle for containing a supply of fuel. Further, the receptacle has a curved sidewall. A pump is positioned within the receptacle wherein the pump generates an acoustical wave having a known frequency. The pump having a pump inlet and wherein the pump inlet is located a 1/4 wavelength of the acoustical wave from the curved sidewall. A receptacle lid is configured to mate with the receptacle to define a closed volume.

### TECHNICAL FIELD

The present invention relates to fuel delivery systems for an automobile and to systems and methods for reducing or eliminating noise generated by the fuel pump of the fuel delivery system.

### BACKGROUND

Conventional fuel delivery systems in automobiles today include a fuel tank and a fuel delivery module (FDM) positioned within the tank. The fuel delivery module, typically, fills with fuel and the fuel is then evacuated from the FDM pumped to the vehicle's engine. Typically, a turbine style pump contained within the fuel delivery module provided the pumping action. While the design and performance characteristics of the pump are well suited for this application, the nature of the design can lead to high frequency noise problems. For example, at certain engine operating conditions such as at engine idle, the pump can produce tones loud enough to be heard by the vehicle occupant. Generally, the source of the high frequency noise is the pump's impeller. The impeller typically has a high number of teeth, such as 47 teeth. Moreover, the pump rotates at 4000 to 5000 rpm at engine idle, thus tones in the 3100 to 3900 hertz range are produced. Unfortunately, this range is well separated and easily distinguishable from engine noise and is also in the most sensitive frequency range of human hearing. Additionally, harmonics of the impeller noise are also within the range of human hearing.

Prior art methods and systems directed to reducing the. noise generated by the pump's impeller have focused on redesigning the impeller. While this effort has resulted in some noise reduction, the efforts often only result in a shift of the frequency of the noise.

The pressure pulsations of the pump originating at the impeller have multiple paths of radiation that can lead to sound generation. For example, the pump vibration may be transferred to the FDM and then to the tank which is a large radiating surface. Another common path is through the fluid or fuel. More specifically, the impeller causes pressure pulsations at the pump's inlet that propagate through the fluid or fuel to the walls of the FDM. The fluid borne pulsations make the tank radiate sound much the same way as the structure borne vibration. However, since the pump is typically vibration isolated, the fluid borne path can be more efficient and thus more noticeable to a vehicle occupant.

Thus, there is a need for a new and improved system and method for reducing or eliminating fluid borne noise. The new and improved system and method should reduce fluid borne noise within a fuel delivery system without significantly increasing cost and complexity to the system.

### SUMMARY

in an aspect of the present invention a fuel delivery module for supplying fuel to an automobile is provided. The fuel deliver module has a receptacle for containing a supply of fuel, the receptacle having a curved sidewall. A pump is positioned within the receptacle wherein the pump generates an acoustical wave having a known frequency. The pump having a pump inlet and wherein the pump inlet is located a 1/4 wavelength of the acoustical wave from the curved sidewall. A receptacle lid is provided and is configured to mate with the receptacle to define a closed volume.

In another aspect of the present invention, the module includes an inlet tube coupled to the pump inlet and a filter coupled to the pump inlet.

In yet another aspect of the present invention, the receptacle lid is positioned at a 1/4 of the wavelength from the bottom of the receptacle and the pump inlet is positioned at a center of a circle defining the curvature of the sidewall.

In still another aspect of the present invention, the sidewall is spherical.

These and other aspects and advantages of the present invention will become apparent upon reading the following detailed description of the invention in combination with the accompanying drawings.

### BRIEF DESCRIPTION OF THE FIGURES

FIG. 1 is a perspective view of a fuel delivery system, in accordance with the present invention;

FIG. 2 is a plan view of a receptacle of a fuel delivery module, in accordance with the present invention;

FIGS. 3 and 4, are plan and cross-sectional views of a receptacle and pump of a fuel deliver module, in accordance with the present invention;

FIG. 5 is a plan view of the receptacle and pump of the fuel deliver module illustrating a semi-spherical sidewall portion disposed opposite the inlet aperture, in accordance with the present invention; and

FIGS. 6 is a plan view of an alternate embodiment of the receptacle illustrating a corrugated sidewall portion disposed opposite the inlet aperture, in accordance with the present invention.

### DETAILED DESCRIPTION

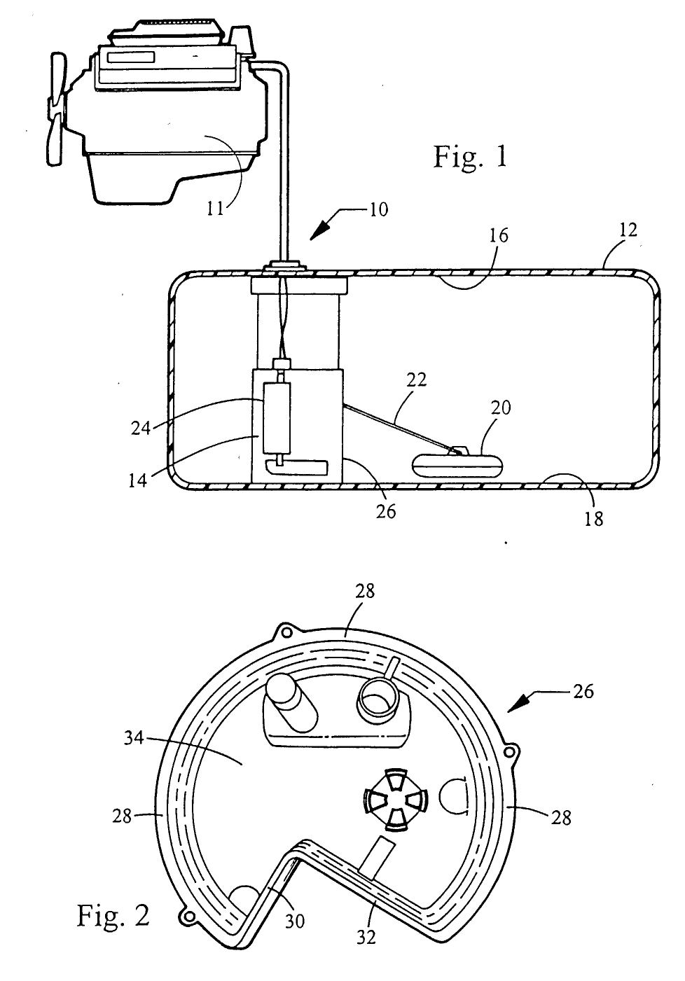

Referring now to FIG. 1, a fuel delivery system 10 for supplying fuel to a vehicle's engine 11 is schematically represented, in accordance with the present invention. Fuel delivery system 10 includes a fuel tank 12 and a fuel delivery module (FDM) 14. Fuel delivery module 14 is disposed within fuel tank 12 and generally attaches to a top surface 16 and a bottom surface 18 of a fuel tank 12. Typically, fuel delivery module 14 includes a float 20 and a float arm 22 for detecting a fuel level within tank 12, as well known in the art. Further, fuel delivery module 14 includes a fuel pump 24 for evacuating fuel drawn into a receptacle 26 of fuel delivery module 14.

Referring now to FIG. 2, a plan view of receptacle 26 of fuel delivery module 14 is further illustrated, in accordance with the present invention. Receptacle 26 generally includes curved sidewalls 28 and in an embodiment straight sidewalls 30 and 32. Straight sidewalls 30 and 32 generally project inward at right angles to curved sidewalls 28. While straight sidewalls 30 and 32 are not a critical aspect of the present invention, walls 30, 32 defines a pocket into which pump 24 is positioned. Further, a receptacle bottom 34 is integrally formed with curved sidewalls 28 and straight sidewalls 30 and 32.

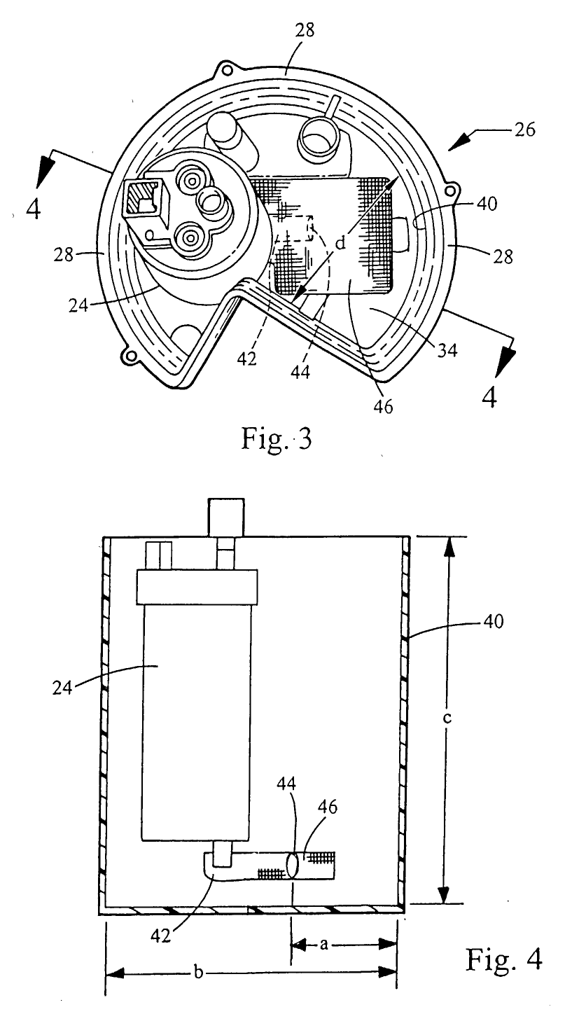

Referring now to FIG. 3, a plan view of receptacle 26 is illustrated with pump 24 installed therein, in accordance with the present invention. Pump 24 is generally positioned opposite an arcuate or curved portion 40 of sidewall 28. However, the present invention contemplates portion 40 of sidewall 28 being flat or non-curved, as well. Further, pump 24 includes a fuel inlet tube 42 disposed proximate to receptacle bottom 34. Inlet tube 42 includes an inlet aperture 44 that receives fuel to be pumped to the vehicle's engine. Generally, a filter 46 is disposed over inlet tube 42 and inlet aperture 44 to prevent debris from entering fuel pump 24.

In operation, an impeller (not shown) within pump 24 spins at high rotational speeds (i.e., 3000 to 9000 rpm) and produces an acoustical wave which emanates from inlet aperture 44. The acoustical wave propagates through the fuel contained within receptacle 26. When the acoustical wave impinges on sidewall portion 40, fuel delivery module 14 starts to vibrate. The vibration of the fuel delivery module causes fuel tank 12 to vibrate and radiate a sound wave. The sound wave traveling through the fuel tank 12 may be more or less noticeable to a vehicle occupant at various engine and vehicle operating conditions, such as at engine idle or during high speed vehicle operation. For example, at engine idle especially, the sound wave may be quite noticeable and become an annoyance to vehicle occupants. Thus, the present invention provides a system and method for eliminating or reducing radiated noise whose source is an acoustical wave at the inlet aperture 44 of pump 24.

Referring now to FIGS. 3 and 4, a plan view and cross-sectional view of receptacle 26 and pump 24 are illustrated, in accordance with the present invention. In a method of the present invention, noise cancellation is provided by maintaining a predetermined distance between inlet aperture 44 of inlet tube 42 and sidewall portion 40. The predefined distance between inlet aperture 44 and sidewall portion 40 is referenced by dimension A in FIG. 4. The present invention contemplates modifying distance A by either shortening or lengthening inlet tube 42 thereby moving inlet aperture 44 closer or farther away from sidewall portion 40 or by moving sidewall portion 40 closer or farther away from inlet aperture 44. Preferably, dimension A is approximately equal to a 1/4 of the wavelength of an acoustical wave generated by the impeller of pump 24 that has been identified as causing a noise problem within the vehicle compartment. Further, in a preferred embodiment sidewall portion 40 is curved and inlet aperture 44 is positioned at the center of a circle that defines the curvature of sidewall portion 40.

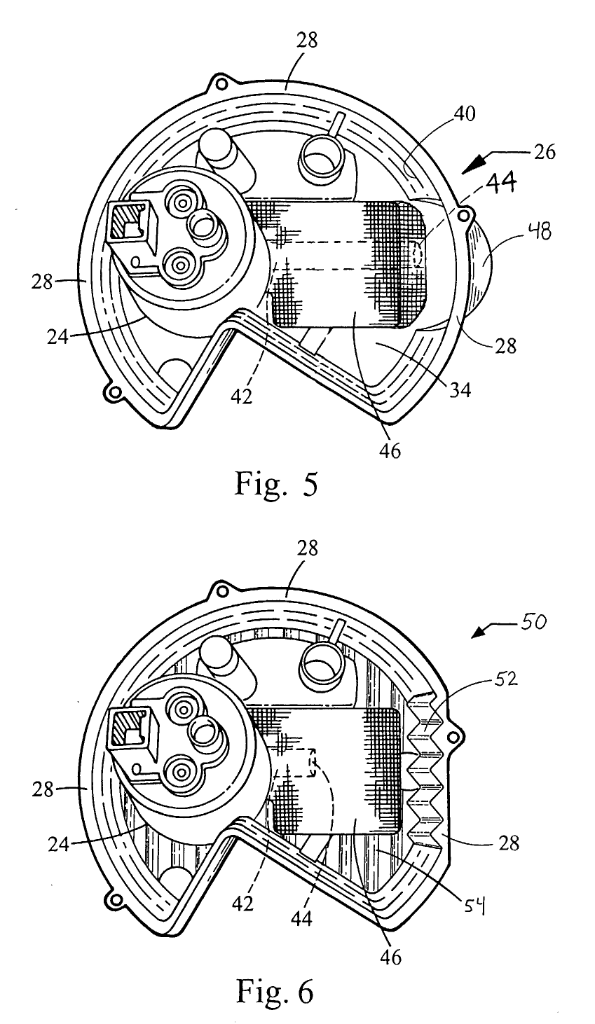

In yet another embodiment of the present invention, shown in FIG. 5, sidewall portion 40 is substituted with a semi-spherical shaped sidewall 48 for focusing pressure pulses, generated by sound waves emanating from the impeller of pump 24, back toward inlet aperture 44 more efficiently. In order to achieve noise cancellation of the acoustic wave generated by the pump's impeller, inlet aperture 44 would preferably be located, approximately, a 1/4 of the wavelength of the acoustical wave from semi-spherical shaped sidewall 48 and positioned at the center of a sphere that defines the semi-spherical sidewall 48.

Finally, the method of the present invention provides a receptacle depth, referenced by dimension C in FIG. 4, of a 1/4 of the wavelength of the acoustical wave in question or alternatively at least not set to half the wavelength of the acoustical wave. Further, other dimensions of receptacle 26 such as dimension B which is the distance between opposing sidewalls 28 and sidewall portion 40 should be so dimensioned to prevent the formation of standing waves, therefore dimensions B should not be near 1/2 the wavelength of the acoustical wave or any integer multiple thereof. Of course, to achieve all of the dimensional limitations stated above for dimensions A, B, and C, receptacle 26 would preferably not be perfectly cylindrical. In other words, opposing sidewalls 28 would not join to form a cylinder. However, a cylindrical receptacle 26 may be used as long as dimensions A and C were held and the inlet aperture 44 was not disposed in the center of a circle that defines the curvature of the cylinder's sidewalls. Thus, the method of the present invention provides noise cancellation by placing the source of the acoustical wave at a predefined distance from a reflective opposing sidewall.

Curved sidewall portion 40 may be integrally molded into receptacle 28 or fixedly secured within receptacle 26 at a predefined distance from sidewall 28. Further, the present invention contemplates changing the distance between inlet aperture 44 and opposing sidewall portion 40 by replacing inlet tube 42 with a longer or shorter tube 42 to arrive at the desired distance from opposing sidewall portion 40. Thus, existing receptacles 26 and pump assemblies 24 may be easily modified without significant design changes and cost.

Referring now to FIG. 6, an alternate embodiment of receptacle 26 is illustrated. The alternate receptacle, referenced by numeral 50, provides a device and a method for avoiding resonances that amplify noise transmitted to the vehicle passenger compartment. This method and device would be used if the previously described cancellation method was not feasible to employ. In opposition to the method for providing noise cancellation, a de-tuning method of the present embodiment provides a non-uniform wall portion 52 opposite inlet aperture 44 to avoid focusing and reflecting the sound wave emanating from inlet 44 back to the source. Preferably, non-uniform wall portion 52 is corrugated to disperse or scatter the sound wave impinging on wall portion 52. Further, the inlet aperture 44 should not be positioned at the center of the receptacle or the center of an arc of the opposing sidewall if the sidewall is curved again, to avoid focusing the reflected acoustic wave back to inlet aperture 44. Further, the various dimensions B, C, D, as shown in FIG. 4, of receptacle 26 should be closer to a 1/4 of the wavelength of the acoustic wave at engine idle rather than to 1/2 the wavelength of the noise generated by the pump's impeller to avoid amplification of the noise due to vertical standing waves. Further, preferably bottom surface 54 of receptacle 50 should also be corrugated to disperse or scatter sound waves impinging thereon and to avoid the formation of vertical standing waves.

Thus, the present invention has many advantages and benefits of the prior art. For example, the present invention provides a system and method for canceling acoustic waves which create noise in vehicle engine compartments. Further, other systems and methods of the present invention reduce or eliminate noise amplification without increasing cost or complexity of the system.

As any person skilled in the art of fuel delivery systems and in methods for reducing or eliminating noise generated by the fuel pump will recognize from the previous detailed description and from the figures and claims, modifications and changes can be made to the preferred embodiments of the invention without departing from the scope of this invention defined in the following claims.

1. A fuel delivery module for supplying fuel to an engine in an automobile, the module comprising:
a receptacle for containing a supply of fuel, the receptacle having a sidewall;
a pump positioned within the receptacle wherein the pump generates an acoustic wave having a known frequency, the pump having a pump inlet and wherein the pump inlet is located a 1/4 wavelength of the acoustic wave from the sidewall; and
a receptacle lid configured to mate with the receptacle to define a closed volume.

2. The module of claim 1 further comprising an inlet tube coupled to the pump inlet.

3. The module of claim 1 further comprising a filter coupled to the pump inlet.

4. The module of claim 1 wherein the receptacle lid is positioned at a 1/4 of the wavelength from the bottom of the receptacle.

5. The module of claim 1 wherein the sidewall is curved.

6. The module of claim 5 wherein the pump inlet is positioned at a center of a circle defining a curvature of the sidewall.

7. The module of claim 1 wherein the sidewall is spherical.

8. The module of claim 1 wherein the sidewall is corrugated.

9. The module of claim 1 wherein the receptacle further comprises a corrugated receptacle bottom.

10. A fuel delivery module for supplying fuel to an engine of an automobile, the module comprising:
a receptacle for containing a supply of fuel, the receptacle having a nonuniform sidewall;
a pump positioned within the receptacle wherein the pump generates an acoustical wave having a known frequency, the pump having a pump inlet and wherein the pump inlet is located opposite the non-uniform sidewall; and
a receptacle lid configured to mate with the receptacle to define a closed volume.

11. The module of claim 10 further comprising an inlet tube coupled to the pump inlet.

12. The module of claim 10 further comprising a filter coupled to the pump inlet.

13. The module of claim 10 wherein the receptacle further comprises a bottom surface being a non-uniform surface.

14. The module of claim 13 wherein the non-uniform surface is a corrugated surface.

15. The module of claim 10 wherein the non-uniform sidewall is a corrugated sidewall.

16. A method for canceling acoustic wave generated by a pump disposed in a fuel delivery module of a vehicle fuel delivery system, the method comprising:
providing a curved wall in the fuel delivery module; and
positioning an inlet of the pump a predefined distance from the curved wall of the fuel delivery module so as to create a reflected acoustic wave that cancels an acoustic wave generated by the pump.

17. The method of claim 16 wherein the predefined distance is a 1/4 wavelength of the acoustic wave.
